(19) United States
(12) Patent Application Publication
(10) Pub. No.: US 2014/0129287 A1
(43) Pub. Date: May 8, 2014

(54) METHOD AND SYSTEM FOR REDUCING ROLL-OUT RISK

(71) Applicant: TIMEST LTD., Jerusalem (IL)

(72) Inventor: Noam BAND, Rosh Haayin (IL)

(73) Assignee: TIMEST LTD., Jerusalem (IL)

(21) Appl. No.: 13/668,486

(22) Filed: Nov. 5, 2012

(51) Int. Cl. G06Q 10/06

(52) U.S. Cl. CPC G06Q 10/0635
USPC 705/7.28

(57) ABSTRACT

A system and method for monitoring business processes implementation in organizations, and more specifically, system and method for reducing roll-out risks.

### FIELD OF THE INVENTION

The current invention relates to the field of monitoring business processes implementation in organizations. More specifically, it deals with the issue of reducing roll-out risks.

### BACKGROUND OF THE INVENTION

Nowadays, in business development of business processes, the most dangerous phase is the implementation phase. The risk in developing for example new software to be implemented in a work place increases in time. This risk rises until the implementation, where the new process is being examined in a real situation. Once this stage is over, the risk obviously has a fast decline.

International patent application WO/2000/046705, claims a system and method for optimizing a business using object models, however it does not disclose interacting with working stations in order to receive live data of business operation, and It does not disclose reducing the risk of the roll-our phase.

There is therefore, a long unmet need, for an efficient system and method that will be able to control the roll out risk when a business process is implemented, using data received during implementation.

### SUMMARY OF THE INVENTION

An object of the invention is thus to disclose a method for reducing rollout risk; the method comprising steps of: (a.) providing: (i) a plurality of N first stations comprising at least one first computer readable medium (FCRM) having first instructions thereon for executing a first business process (FBP); and (ii) a plurality of M second stations comprising at least one second computer readable medium (SCRM) having second instructions thereon for executing a second business process (SBP); N is an integer larger than zero; M is an integer larger than zero; (b.) mining the FBP from each of the FCRM by means of a first sub-system; (c.) generating first efficiency parameter for first instructions; (d.) mining the SBP from each of the SCRM by means of a second sub-system; (e.) generating second efficiency parameter for second instructions; (f.) communicating between at least one third computer readable medium (TCRM) having third instructions thereon and: (i) each of the FCRM; and (ii) each of the SCRM; (g.) estimating by means of the third instructions roll-out risk of the SBP according to: (i) first efficiency parameter; and (ii) second efficiency parameter, wherein the method, additionally comprising step of: (h.) automatically interpreting screen usage on a plurality of stations using the first sub-system and the second sub-system.

It is another object of the current invention to disclose the method as defined above, wherein at least one of: first sub-system, second sub-system comprising: (a) an Object Model (OM) instance log extracting means; (b) a fourth computer readable medium containing (i) an OM instance log obtained from the extracting means; (ii) a first database containing a plurality of business process models; (iii) fourth instructions for automatically ranking according to a predetermined metric, the matching of the contents of said OM instance log to at least one of plurality of the business process models; (iv) a second log of closest match for each of said OM instance, according to the ranking; and (c) a displaying means for displaying the log closest match, the OM instance log derives from a second system for automatically interpreting screen usage on a plurality of the stations.

It is another object of the current invention to disclose the method as defined above, additionally comprising step of selecting the object from a group consisting of screen types, Button Control Type, Calendar Control Type, CheckBox Control Type, ComboBox Control Type, DataGrid Control Type, Data Item Control Type, Document Control Type, Edit Control Type, Group Control Type, Header Control Type, HeaderItem Control Type, Hyperlink Control Type, Image Control Type, List Control Type, ListItem Control Type, Menu Control Type, MenuBar Control Type, Menu Item Control Type, Pane Control Type, ProgressBar Control Type, RadioButton Control Type, ScrollBar Control Type, Separator Control Type, Slider Control Type, Spinner Control Type, SplitButton Control Type, StatusBar Control Type, Tab Control Type, TabItem Control Type, Table Control Type, Text Control Type, Thumb Control Type, TitleBar Control Type, ToolBar Control Type, ToolTip Control Type, Tree Control Type, TreeItem Control Type, Window Control Type or any combination thereof.

It is another object of the current invention to disclose the method as defined above, additionally comprising step of repeating the method by changing N and M according to the roll-out risk estimation.

It is another object of the current invention to disclose the method as defined above, additionally comprising step of establishing a range of roll out risk.

It is another object of the current invention to disclose the method as defined above additionally comprising step of increasing M and reducing N if the roll-out estimation is within the range.

Another object of the invention is thus to disclose a system for reducing rollout risk, the system comprising: (a.) a plurality of N first stations, each of the first stations comprises at least one first computer readable medium (FCRM) having first instructions thereon for executing a FBP; (b.) a first sub-system for mining the FBP from each of the FCRM, the first instructions are for generating first efficiency parameter for first instructions; (c.) a plurality of M second stations, each of the second stations comprises at least one second computer readable medium (SCRM) having second instructions thereon for executing a second business process (SBP); (d.) a second sub-system for mining the SBP from each of the SCRM, the second instructions are for generating second efficiency parameter for SBP; (e.) at least one third computer readable medium (TCRM) having third instructions thereon, the TCRM is in communication with: (i) each of the FCRM; and (ii) each of the SCRM, the third instructions are for estimating roll-out risk of the SBP according to: (i) first efficiency parameter; and (ii) second efficiency parameter, wherein the first sub-system and the second sub-system are for automatically interpreting screen usage on a plurality of stations; N is an integer larger than zero; M is an integer larger than zero.

It is another object of the current invention to disclose the system as defined above, wherein at least one of the first sub-system, the second sub-system comprising: (a.) an Object Model (OM) instance log extracting means; (b.) a fourth computer readable medium containing (i.) an OM instance log obtained from said extracting means; (ii.) a first database containing a plurality of business process models; (iii.) fourth instructions for automatically ranking according to a predetermined metric, the matching of the contents of the OM instance log to at least one of said plurality of the business process models; (iv.) a second log of closest match for each of the OM instance, according to the ranking; and (c.) a displaying means for displaying the log closest match, the OM instance log derives from a second system for automatically interpreting screen usage on a plurality of stations.

It is another object of the current invention to disclose the system as defined above, wherein the object is selected from a group consisting of screen types, Button Control Type, Calendar Control Type, CheckBox Control Type, ComboBox Control Type, DataGrid Control Type, Data Item Control Type, Document Control Type, Edit Control Type, Group Control Type, Header Control Type, HeaderItem Control Type, Hyperlink Control Type, Image Control Type, List Control Type, ListItem Control Type, Menu Control Type, MenuBar Control Type, Menu Item Control Type, Pane Control Type, ProgressBar Control Type, RadioButton Control Type, ScrollBar Control Type, Separator Control Type, Slider Control Type, Spinner Control Type, SplitButton Control Type, StatusBar Control Type, Tab Control Type, TabItem Control Type, Table Control Type, Text Control Type, Thumb Control Type, TitleBar Control Type, ToolBar Control Type, ToolTip Control Type, Tree Control Type, TreeItem Control Type, Window Control Type or any combination thereof.

It is another object of the current invention to disclose the system as defined above, wherein the estimation of roll-out risk is repeated by changing N and M according to the roll-out risk estimation.

It is another object of the current invention to disclose the system as defined above, wherein the system comprises a range of roll out risk.

It is another object of the current invention to disclose the system as defined above, wherein the estimation is repeated with increased M and reduced N if said roll-out estimation is within the predetermined range.

### BRIEF DESCRIPTION OF THE DRAWINGS

In order to understand the invention and to see how it may be implemented in practice, a few preferred embodiments will now be described, by way of non-limiting example only, with reference to be accompanying drawings, in which:

FIG. 1 describes a flow chart of a method for reducing rollout risk.

FIG. 2 shows a system for reduction of roll out risk.

FIG. 3 discloses a system for automatically interpreting screen usage.

### DETAILED DESCRIPTION OF THE INVENTION

The following description is provided so as to enable any person skilled in the art to make use of the invention and sets forth examples contemplated by the inventor of carrying out this invention. Various modifications, however, will remain apparent to those skilled in the art, since the generic principles of the present invention have been defined specifically. Also, it is to be understood that the phraseology and terminology employed herein is for the purpose of description and should not be regarded as limiting.

An object of the invention is thus to disclose a method for reducing rollout risk; the method comprising steps of: (a.) providing: (i) a plurality of N first stations comprising at least one first computer readable medium (FCRM) having first instructions thereon for executing a first business process (FBP); and (ii) a plurality of M second stations comprising at least one second computer readable medium (SCRM) having second instructions thereon for executing a second business process (SBP); N is an integer larger than zero and M is an integer larger than zero; (b.) mining the FBP from each of the FCRM by means of a first sub-system; (c.) generating first efficiency parameter for first instructions; (d.) mining the SBP from each of the SCRM by means of a second sub-system; (e.) generating second efficiency parameter for second instructions; (f.) communicating between at least one third computer readable medium (TCRM) having third instructions thereon and: (i) each of the FCRM; and (ii) each of the SCRM; (g.) estimating by means of the third instructions roll-out risk of the SBP according to: (i) first efficiency parameter; and (ii) second efficiency parameter, wherein the method, additionally comprising step of: (h.) automatically interpreting screen usage on a plurality of stations using the first sub-system and the second sub-system.

Another object of the invention is thus to disclose a system for reducing rollout risk; the system comprising: (a.) a plurality of N first stations; each of the first stations comprises at least one first computer readable medium (FCRM) having first instructions thereon for executing a FBP; (b.) a first sub-system for mining the FBP from each of the FCRM, the first instructions are for generating first efficiency parameter for first instructions; (c.) a plurality of M second stations, each of the second stations comprises at least one second computer readable medium (SCRM) having second instructions thereon for executing a second business process (SBP); (d.) a second sub-system for mining the SBP from each of the SCRM, the second instructions are for generating second efficiency parameter for SBP; (e.) at least one third computer readable medium (TCRM) having third instructions thereon, the TCRM is in communication with: (i) each of the FCRM; and (ii) each of the SCRM, the third instructions are for estimating roll-out risk of the SBP according to: (i) first efficiency parameter; and (ii) second efficiency parameter, wherein, the first sub-system and the second sub-system are for automatically interpreting screen usage on a plurality of stations; N is an integer larger than zero and M is an integer larger than zero.

The term “Roll-Out” refers hereinafter to any process which aims to integrate a new product, more specifically it relates to the time in which the products is in its first implementation stage.

The term “computer readable medium” refers hereinafter to any medium that is capable of storing or encoding a sequence of instructions for execution by a computer and that cause the computer to perform any one of the methodologies of the present invention, it includes, but is not limited to, solid-state memories, optical and magnetic disks, and carrier wave signals.

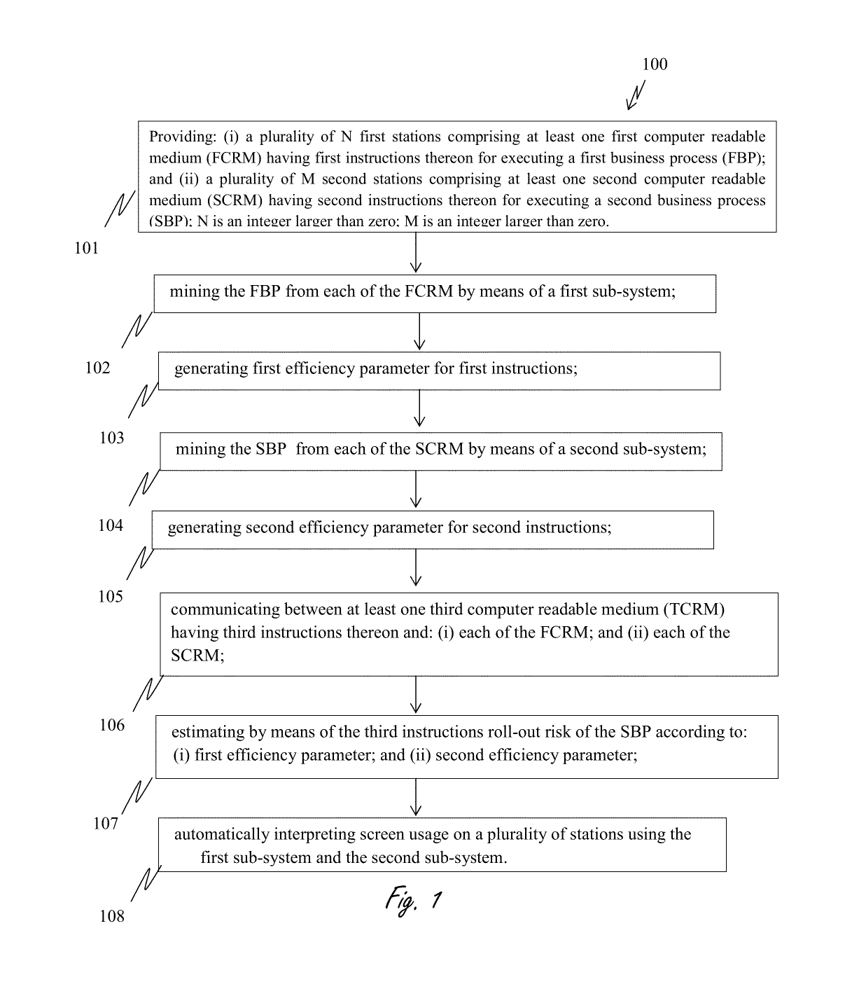

Reference is now made to FIG. 1, which illustrates in a non-limiting manner, a flow chart for a method 100 for reducing rollout risk; the method comprising: (a.) step 201 of providing: (i) a plurality of N first stations comprising at least one first computer readable medium (FCRM) having first instructions thereon for executing a first business process (FBP); and (ii) a plurality of M second stations comprising at least one second computer readable medium (SCRM) having second instructions thereon for executing a second business process (SBP), N is an integer larger than zero and M is an integer larger than zero; (b.) step 202 of mining the FBP from each of the FCRM by means of a first sub-system; (c.) step 203 of generating first efficiency parameter for first instructions; (d.) step 204 of mining the SBP from each of the SCRM by means of a second sub-system; (e.) step 205 of generating second efficiency parameter for second instructions; (f.) step 206 of communicating between at least one third computer readable medium (TCRM) having third instructions thereon and: (i) each of the FCRM; and (ii) each of the SCRM; (g.) step 207 of estimating by means of the third instructions roll-out risk of the SBP according to: (i) first efficiency parameter; and (ii) second efficiency parameter, wherein the method, additionally comprising step of: (h) step 208 of automatically interpreting screen usage on a plurality of stations using the first sub-system and the second sub-system.

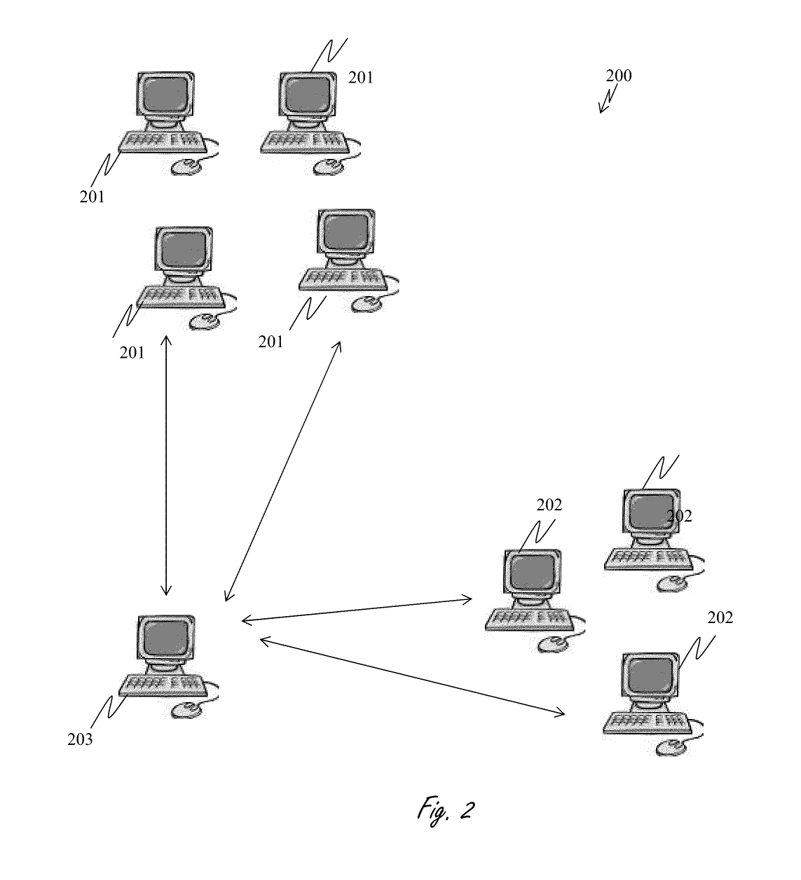

Reference is now made to FIG. 2 which shows in a non-limiting a system 200 for reducing rollout risk, the system comprising: (a.) a plurality of N first stations; each of the first stations comprises at least one first computer readable medium (FCRM) 201 having first instructions thereon for executing a FBP; (b.) a first sub-system for mining the FBP from each of the FCRM 201, the first instructions are for generating first efficiency parameter for first instructions; (c.) a plurality of M second stations, each of the second stations comprises at least one second computer readable medium (SCRM) 202 having second instructions thereon for executing a second business process (SBP); (d.) a second sub-system for mining the SBP from each of the SCRM 202, the second instructions are for generating second efficiency parameter for SBP; (e.) at least one third computer readable medium (TCRM) having third instructions thereon; the TCRM 203 is in communication with: (i) each of the FCRM 201; and (ii) each of the SCRM 202, the third instructions are for estimating roll-out risk of the SBP according to: (i) first efficiency parameter; and (ii) second efficiency parameter, wherein, the first sub-system and the second sub-system are for automatically interpreting screen usage on a plurality of stations, N is an integer larger than zero and M is an integer larger than zero.

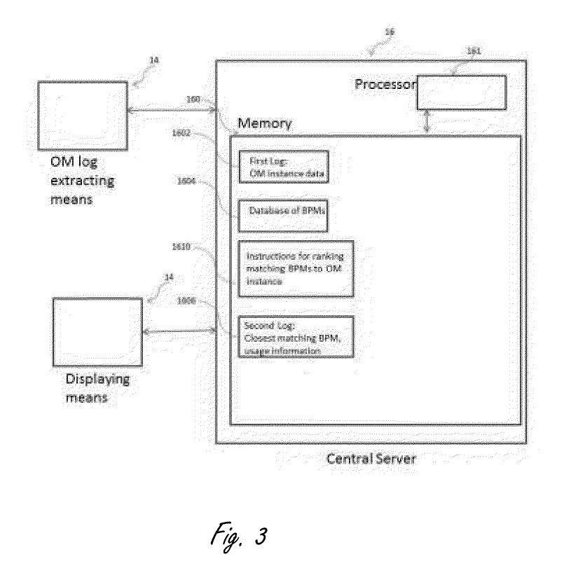

Reference is now made to FIG. 3, which describes in a non-limiting manner, at least one of the first sub-system, the second sub-system comprising: (a.) an Object Model (OM) instance log extracting means 14; (b.) a fourth computer readable medium 160 containing: (i.) an OM instance log 1602 obtained from said extracting means; (ii.) a first database containing a plurality of business process models 1604; (iii.) fourth instructions 1601 for automatically ranking according to a predetermined metric, the matching of the contents of the OM instance log to at least one of said plurality of the business process models; (iv.) a second log 1606 of closest match for each of the OM instance, according to the ranking; and (c.) a displaying means 14 for displaying the log closest match, the OM instance log derives from a second system for automatically interpreting screen usage on a plurality of stations.

In some embodiments of the current invention, the object as defined above is selected from a group consisting of screen types, Button Control Type, Calendar Control Type, CheckBox Control Type, ComboBox Control Type, DataGrid Control Type, Data Item Control Type, Document Control Type, Edit Control Type, Group Control Type, Header Control Type, HeaderItem Control Type, Hyperlink Control Type, Image Control Type, List Control Type, ListItem Control Type, Menu Control Type, MenuBar Control Type, Menu Item Control Type, Pane Control Type, ProgressBar Control Type, RadioButton Control Type, ScrollBar Control Type, Separator Control Type, Slider Control Type, Spinner Control Type, SplitButton Control Type, StatusBar Control Type, Tab Control Type, TabItem Control Type, Table Control Type, Text Control Type, Thumb Control Type, TitleBar Control Type, ToolBar Control Type, ToolTip Control Type, Tree Control Type, TreeItem Control Type, Window Control Type or any combination thereof.

In some embodiments of the current invention, the estimation of the roll-out risk is estimated repeatedly. At each time such estimation is performed, the numbers N and M are changing. That is, for example, if the risk is very low than the SBP will be implemented in more stations, hence, increasing the number M and reducing the number N. This change of numbers can be done for example according to a predetermined range of roll out risk. When the risk is within the predetermined range, the implementation process will continue.

### EXAMPLE 1

In one example of the current invention, a factory transfers its entire computer system to a new program. The implementation is done gradually, where at a first stage, only a small portion of the computers are installed with the new program, and the rest of the computers are with the old program. A program installed on all the computers detects the business model during work, and from that data produces an efficiency parameter. If the partial implementation is successful according to the parameters produced, than more and more computers are installed with the new program. The entire computer system is finally installed with the new program only after a careful analysis of each stage in the implementation using a program that can mine business processes from each computer is done, hence, reducing roll-out risk.

It will be appreciated by persons skilled in the art that embodiment of the invention are not limited by what has been particularly shown and described hereinabove. Rather the scope of at least one embodiment of the invention is defined by the claims below.

What is claimed is:

1. A method for reducing rollout risk; said method comprising steps of:
a. providing: (i) a plurality of N first stations comprising at least one first computer readable medium (FCRM) having first instructions thereon for executing a first business process (FBP); and (ii) a plurality of M second stations comprising at least one second computer readable medium (SCRM) having second instructions thereon for executing a second business process (SBP); said N is an integer larger than zero; said M is an integer larger than zero;
b. mining said FBP from each of said FCRM by means of a first sub-system;
c. generating first efficiency parameter for first instructions;
d. mining said SBP from each of said SCRM by means of a second sub-system;
e. generating second efficiency parameter for second instructions;
f. communicating between at least one third computer readable medium (TCRM) having third instructions thereon and: (i) each of said FCRM; and (ii) each of said SCRM;
g. estimating by means of said third instructions roll-out risk of said SBP according to: (i) said first efficiency parameter; and (ii) said second efficiency parameter;
wherein said method, additionally comprising step of:
h. automatically interpreting screen usage on a plurality of stations using said first sub-system and said second sub-system.

2. The method according to claim 1, wherein at least one of said first sub-system, said second sub-system comprising:
a) an Object Model (OM) instance log extracting means;
b) a fourth computer readable medium containing:
i) an OM instance log obtained from said extracting means;
ii) a first database containing a plurality of business process models;
iii) fourth instructions for automatically ranking according to a predetermined metric, the matching of the contents of said OM instance log to at least one of said plurality of said business process models;
iv) a second log of closest match for each of said OM instance, according to said ranking; and
c) a displaying means for displaying said log closest match,
said OM instance log derives from a second system for automatically interpreting screen usage on a plurality of said stations.

3. The method according to claim 2, additionally comprising step of selecting said object from a group consisting of screen types, Button Control Type, Calendar Control Type, CheckBox Control Type, ComboBox Control Type, DataGrid Control Type, Data Item Control Type, Document Control Type, Edit Control Type, Group Control Type, Header Control Type, HeaderItem Control Type, Hyperlink Control Type, Image Control Type, List Control Type, ListItem Control Type, Menu Control Type, MenuBar Control Type, Menu Item Control Type, Pane Control Type, ProgressBar Control Type, RadioButton Control Type, ScrollBar Control Type, Separator Control Type, Slider Control Type, Spinner Control Type, SplitButton Control Type, StatusBar Control Type, Tab Control Type, TabItem Control Type, Table Control Type, Text Control Type, Thumb Control Type, TitleBar Control Type, ToolBar Control Type, ToolTip Control Type, Tree Control Type, TreeItem Control Type, Window Control Type or any combination thereof.

4. The method according to claim 1, additionally comprising step of repeating said method by changing said N and said M according to said roll-out risk estimation.

5. The method according to claim 4, additionally comprising step of establishing a range of roll out risk.

6. The method according to claim 4, additionally comprising step of increasing said M and reducing said N if said roll-out estimation is within said range.

7. The method according to claim 5, additionally comprising step of increasing said M and reducing said N if said roll-out estimation is within said range.

8. A system for reducing rollout risk; said system comprising
a. a plurality of N first stations; each of said first stations comprises at least one first computer readable medium (FCRM) having first instructions thereon for executing a first business process (FBP);
b. a first sub-system for mining said FBP from each of said FCRM; said first instructions are for generating first efficiency parameter for first instructions;
c. a plurality of M second stations; each of said second stations comprises at least one second computer readable medium (SCRM) having second instructions thereon for executing a second business process (SBP);
d. a second sub-system for mining said SBP from each of said SCRM; said second instructions are for generating second efficiency parameter for SBP;
e. at least one third computer readable medium (TCRM) having third instructions thereon; said TCRM is in communication with: (i) each of said FCRM; and (ii) each of said SCRM; said third instructions are for estimating roll-out risk of said SBP according to: (i) said first efficiency parameter; and (ii) said second efficiency parameter;
wherein, said first sub-system and said second sub-system are for automatically interpreting screen usage on a plurality of stations; said N is an integer larger than zero; said M is an integer larger than zero.

9. The system according to claim 8, wherein at least one of said first sub-system, said second sub-system comprising:
a) an Object Model (OM) instance log extracting means;
b) a fourth computer readable medium containing:
i) an OM instance log obtained from said extracting means;
ii) a first database containing a plurality of business process models;
iii) fourth instructions for automatically ranking according to a predetermined metric, the matching of the contents of said OM instance log to at least one of said plurality of said business process models;
iv) a second log of closest match for each of said OM instance, according to said ranking; and
c) a displaying means for displaying said log closest match,
said OM instance log derives from a second system for automatically interpreting screen usage on a plurality of said stations.

10. The system of claim 9, wherein said object is selected from a group consisting of screen types, Button Control Type, Calendar Control Type, CheckBox Control Type, ComboBox Control Type, DataGrid Control Type, Data Item Control Type, Document Control Type, Edit Control Type, Group Control Type, Header Control Type, HeaderItem Control Type, Hyperlink Control Type, Image Control Type, List Control Type, ListItem Control Type, Menu Control Type, MenuBar Control Type, Menu Item Control Type, Pane Control Type, ProgressBar Control Type, RadioButton Control Type, ScrollBar Control Type, Separator Control Type, Slider Control Type, Spinner Control Type, SplitButton Control Type, StatusBar Control Type ,Tab Control Type, TabItem Control Type, Table Control Type, Text Control Type, Thumb Control Type, TitleBar Control Type, ToolBar Control Type, ToolTip Control Type, Tree Control Type, TreeItem Control Type, Window Control Type or any combination thereof.

11. The system of claim 8, wherein said estimation of roll-out risk is repeated by changing said N and M according to said roll-out risk estimation.

12. The system of claim 11, wherein said system comprises a range of roll out risk.

13. The system of claim 11, wherein said estimation is repeated with increased said M and reduced said N if said roll-out estimation is within said predetermined range.

14. The system of claim 12, wherein said estimation is repeated with increased said M and reduced said N if said roll-out estimation is within said predetermined range.
